(19) United States
(12) Patent Application Publication
(10) Pub. No.: US 2020/0114632 A1
(43) Pub. Date: Apr. 16, 2020

(54) ECOLOGICAL MINERAL PAPER MADE OF RECYCLED PLASTIC AND METHOD FOR PRODUCING SAME

(71) Applicant: INDUSTRIAS SUSTENTABLES NAVA, S.A.P.I. DE C.V., Metepec (MX)

(72) Inventors: Ranganath K. SHASTRI, Metepec (MX); Eder Adrián NAVA MARTÍNEZ, Ecatepec (MX); Paulina Mariana CABALLERO GUTIÉRREZ, Iztacalco Ciudad (MX); Isaí Javier ORTIZ GUTIÉRREZ, Iztacalco Ciudad (MX); Carlos Armando PÉREZ VALDÉS, Iztapalapa Ciudad (MX)

(73) Assignee: INDUSTRIAS SUSTENTABLES NAVA, S.A.P.I. DE C.V., Metepec (MX)

(21) Appl. No.: 16/606,023

(22) PCT Filed: Apr. 3, 2018
(86) PCT No.: PCT/IB2018/052302

§ 371 Date: Oct. 17, 2019

(30) Foreign Application Priority Data
Apr. 20, 2017 (MX) MX/A/2017/005123

(51) Int. Cl. B32B 27/20; B32B 27/08; B32B 27/36; B32B 37/20; B29C 48/00; B29C 48/08; B29B 17/04; B32B 27/32; B29B 7/90

(52) U.S. Cl. CPC B32B 27/20; B32B 27/08; B32B 27/36; B32B 37/203; B29K 2067/003; B29C 48/08; B29B 17/0412; B32B 27/32; B29B 7/90; B29C 48/022

(57) ABSTRACT

A synthetic mineral paper as substitute to cellulosic paper and a process for producing the same are provided.

### FIELD OF THE INVENTION

The present invention relates to the field of recycled materials for environmental care. Specifically, the present invention relates to a synthetic mineral paper made from recycled plastics.

### BACKGROUND OF THE INVENTION

A mineral paper or stone paper differs from the conventional cellulosic paper and differs as it incorporates a high mineral content, where the minerals are typically CaCO₃, Talc, Silica, etc.

In most cases, they are based on a polymer matrix, generally virgin polyolefin resins such as PE or PP.

Patent application WO 2014/169454 A1 by Hong Kong Green Angel Technology Ltd. describes a coextruded structure with 2 or 3 PVC-based layers, consisting of surface layer(s) of a resin mixture and TiO₂, with the central layer making up 90% of the thickness, made of a resin mixture with CaCO₃, intended for use as sheet paper for furniture.

Patent application WO 2014/169448 A1 by Hong Kong Green Angel Technology Ltd. relates to a ecologic stone paper in the form of a coextruded structure of 3 base layers of polyolefin resins (LDPE, HDPE, LLDPE or PP) which consists of surface layer(s) of a resin mixture and TiO₂ while the central layer that makes up 90% of the thickness, is made of a resin mixture with fibers having a length of 10-15 mm and to the process for the production thereof.

US patent application 2014/0135423 A1 by Real Green Material Technology Corporation of Taiwan refers to an eco-friendly writing stone paper free of CaCO₃, made by extrusion of pellets produced from a mixture of stone dust, silica powder in the size range of 10⁻⁶ to 10⁻⁹ m and polyolefin resin (PE and PP) and the process to produce the same, as well as the surface treatment to obtain good ink absorption.

U.S. Pat. No. 7,938,933 B2 assigned to the Atomic Energy Council—Institute of Nuclear Energy Research of Taiwan, describes the process of making a refractory mineral fiber paper using a wet papermaking machine by mixing a solution of 30 to 50% refractory mineral fiber and PVA resin with a solution of 50 to 70% polyethylene fiber and PVA resin.

Patent application WO 2013/185392 A1 describes the process for making a stone paper that is oriented in the longitudinal direction 2-7 times to align the stone dust in one direction allowing for free tearing using a smooth straight edge blade.

patent application WO 01/38425 A2 by Trespaphan GmbH describes a biaxially oriented multilayer film made of resins such as polyolefins, polyamide, polyester or PVC with natural or mineral fibers in at least one layer.

In theory, a mineral paper does not need to include a polymer matrix.

U.S. Pat. No. 9,200,411 B2 assigned to New Millenium LLC describes a process for manufacturing mineral paper with a density of 0.5 g/cc compared to 0.7 to 0.9 g/cc of a paper based on cellulosic pulp, by extrusion in the processing range of 149° C. to 221° C. of pellets formed from a mixture of 50% to 70% of milled rocks of 0.05 to 0.08 mm in diameter, 30% to 50% of Sodium Silicate solution and 2% to 5% of additives, including vitamins.

The document DE2710996 A1 describes a paper containing mineral fibers, wool fibers, a binder and a resin with carboxylic groups. This paper is used as a filter material to manufacture protective clothing.

The document CN101851365 describes a mineral paper comprising polyethylene, hot-melt adhesive, titanium dioxide, calcium carbonate, a silane coupling agent, stearic acid, an epoxy plasticizer and polyethylene wax.

The document CN102910859 describes a method of manufacturing a mineral paper comprising CaO which, through a series of steps, is converted into a low-density calcium carbonate which results in a mineral paper.

The document GB1127973 describes a polymeric paper comprising a polymer other than PET and solid matter.

### OBJECTIVES OF THE INVENTION

It is an object of the present invention to provide a synthetic mineral paper.

It is another object of the present invention to provide a method to manufacture the synthetic mineral paper.

### DESCRIPTION OF THE FIGURES

FIG. 1 illustrates a block diagram of the manufacturing process of the present invention.

FIG. 2 illustrates another block diagram of a further embodiment of the manufacturing process of the present invention.

FIG. 3 illustrates a further embodiment of the manufacturing process of the present invention.

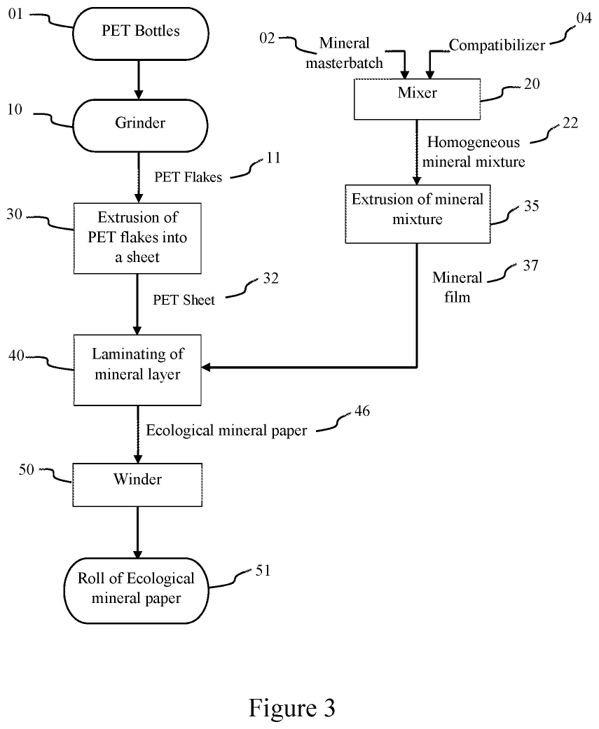

FIG. 4 refers to still another further embodiment of the manufacturing process of the present invention.

FIG. 5 shows another further embodiment of the manufacturing process of the present invention.

FIG. 6 illustrates another further embodiment of the manufacturing process of the present invention.

FIG. 7 refers to another further embodiment of the manufacturing process of the present invention.

FIG. 8 represents another manufacturing embodiment of the production process of the present invention.

### DETAILED DESCRIPTION OF THE INVENTION

The present invention relates to an environmentally friendly synthetic mineral paper by using recycled plastics, but it is not limited to residues of PET bottles, the paper further comprises naturally available minerals.

Processes for producing synthetic paper are also contemplated.

The synthetic paper of the present invention provides as technical advantages, moisture impermeability, foldability, tear resistance, scratch resistance, anti-fungal and antimicrobial characteristics, chemical and grease resistance, high temperature resistance above 200° C., degradability. It also allows printing on its surface with any type of printer, e.g. laser, offset or digital printer, and can be adapted for use in packaging, labels, signs or maps as a substitute for conventional cellulosic paper.

In one embodiment of the present invention, the composition of ecological mineral paper consists of:
1. 33% to 78% Polymeric matrix, mainly PET bottle wastes (soft drinks, water, juices etc.),
2. 20% to 60% Natural mineral, mainly calcium carbonate, CaCO₃,
3. 1% to 2% Dispersion agent, mainly polymeric, such as SOLPLUS, and
4. 1% to 5% Compatibilizer, especially with mineral masterbatch in PE,

The polymer matrix is not limited only to recycled PET and it includes recycled non-foamed PE or PP products.

In the same manner, the mineral is not limited to CaCO₃ and includes talc, mica, marble, TiO₂, etc.

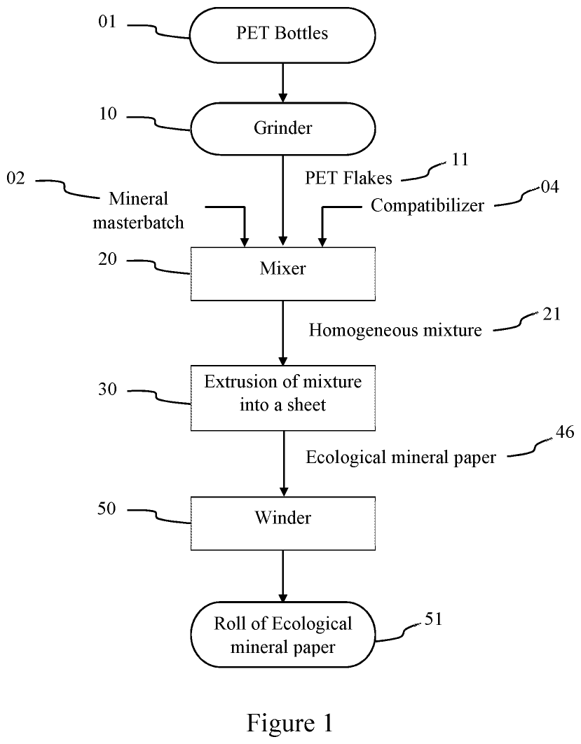

In a preferred embodiment of FIG. 1, the process of the present invention comprises grinding the PET bottle wastes 01 in a grinder 10 to obtain PET flakes 11, which are mixed with the concentrated mineral masterbatch 02 such as calcium carbonate or talc or mica in a polymer matrix such as PE, with an appropriate compatibilizer 04 in predetermined proportions, using a mechanical mixing device 20 for a predetermined period of time that will ensure a homogeneous mixture 21. The obtained homogeneous mixture 21 is extruded into an ecological mineral paper 46 of a desired thickness using a sheet extrusion system 30, which is then wound into a roll using a winder 50 to produce a roll of ecological mineral paper 51.

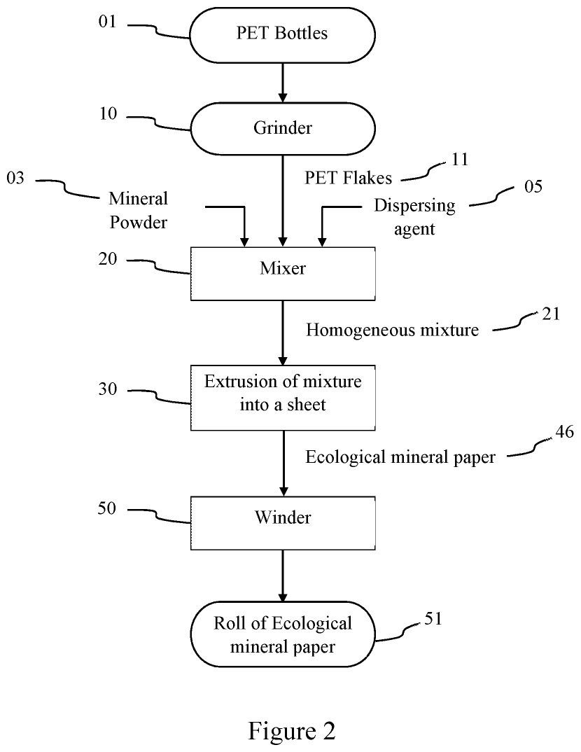

In another alternative embodiment of the present invention. FIG. 2, the process comprises grinding the PET bottle wastes 01 in a grinder 10 to obtain PET flakes 11, which are mixed with mineral powder 03 such as calcium carbonate or talc or mica, with a dispersion agent 05 in predetermined proportions, using a mechanical mixing device 20 for a predetermined period of time that will ensure a homogeneous mixture. The obtained homogeneous mixture 21 is extruded into an ecological mineral paper 46 of a desired thickness using a sheet extrusion system 30, which is wound into a roll using a winder 50 to produce an ecological mineral paper roll 51.

Unlike these options of premixing the components, an alternative embodiment of the process comprises:
i. grinding the PET bottle wastes 01 in a grinder 10 to obtain PET flakes 11, which are extruded into a PET sheet 32 of a desired thickness using a sheet extrusion system 30. The concentrated masterbatch 02 of minerals such as carbonate of calcium or talc or mica is mixed separately in a polymer matrix such as PE, with an appropriate compatibilizer 04 in predetermined proportions, using a mechanical mixing device 20 for a predetermined period of time that will ensure a homogeneous mixture. The obtained homogeneous mineral mixture 22 is extruded into a mineral film 37 of a width identical to that of the PET sheet 32 using another flat film extrusion system 35, which is then laminated on both sides of the PET sheet 32 using a laminating device 40 to form an ecological mineral paper 46, which is then wound into a roll using a winder 50 to produce an ecological mineral paper roll 51.

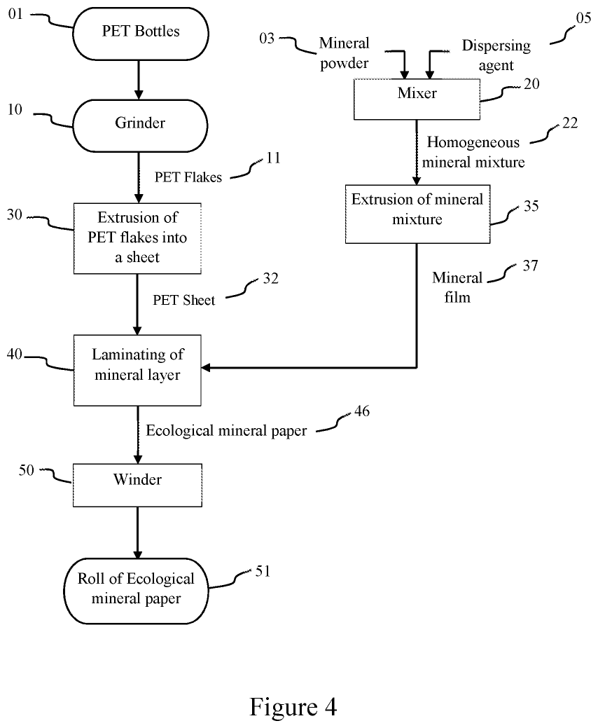

Another possible alternative is as shown in FIG. 4, which is described as follows:
ii. grinding the PET bottle wastes 01 in a grinder 10 to obtain PET flakes 11 that are then extruded into a PET sheet 32 of a desired thickness using a sheet extrusion system 30. The mineral powder 03 such as calcium carbonate or talc or mica is mixed separately with a dispersing agent 05 in predetermined proportions, using a mechanical mixing device 20 for a predetermined period of time that will ensure a homogeneous mixture. The obtained homogeneous mineral mixture 22 is extruded into a mineral film 37 of a width identical to that of the PET sheet 32 using another flat film extrusion system 35, which is laminated on both sides of the PET sheet 32 using a laminating device 40 to form an ecological mineral paper 46 which is wound into a roll using a winder 50 to produce a roll of organic mineral paper 51.

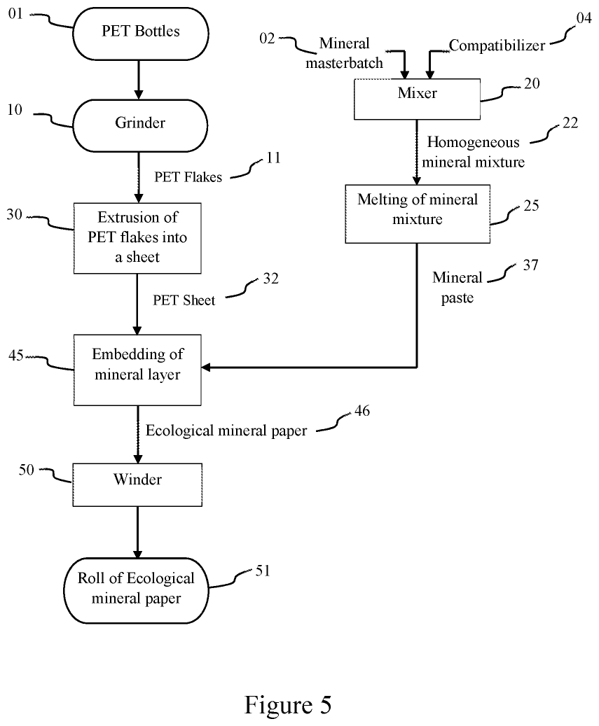

Additionally, another alternative embodiment of the process comprises (FIG. 5):
iii. grinding the PET bottle wastes 01 in a grinder 10 to obtain PET flakes 11, which are then extruded into a PET sheet 32 of a desired thickness using a sheet extrusion system 30. The concentrated mineral masterbatch 02 is mixed separately in a polymer matrix such as PE, with an appropriate compatibilizer 04 in predetermined proportions, using a mechanical mixing device 20 for a predetermined period of time that will ensure a homogeneous mixture. The obtained homogeneous mineral mixture 22 is melted in a melting device 25 to produce a mineral paste 38, which is then embedded in both sides of the PET sheet 32 using a coating device 45 to form an ecological mineral paper 46 that is wound into a roll using a winder 50 to produce a roll of ecological mineral paper 51.

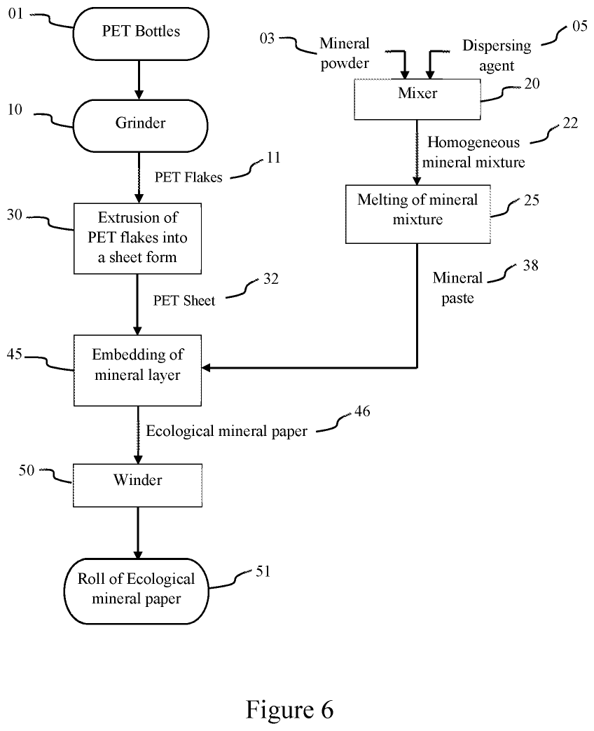

FIG. 6 shows another embodiment of the process to obtain an ecological mineral paper:
iv. grinding the PET bottle wastes 01 in a grinder 10 to obtain PET flakes 11, which are then extruded into a PET sheet 32 of a desired thickness using a sheet extrusion system 30. The mineral powder a 03 is mixed separately with a dispersing agent 05 in predetermined proportions, using a mechanical mixing device 20 for a predetermined period of time that will ensure a homogeneous mixture. The obtained homogeneous mineral mixture 22 is melted in a melting device 25 to produce a mineral paste 38, which is embedded in both sides of the PET sheet 32 using a coating device 45 to form an ecological mineral paper 46 that is wound into a roll using a winder 50 to produce a roll of ecological mineral paper 51.

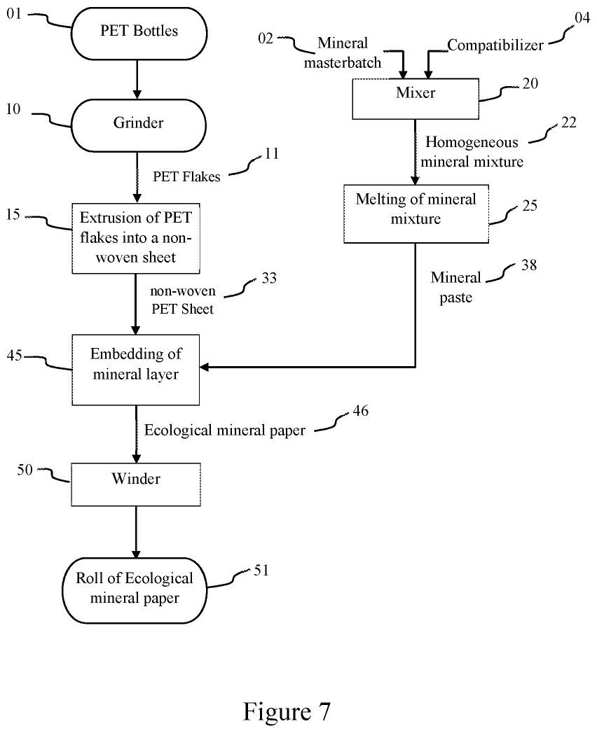

In addition, another alternative embodiment of the process (FIG. 7) comprises:
v. grinding the PET bottle wastes 01 in a grinder 10 to obtain PET flakes 11, which are extruded into a non-woven PET sheet 33 of a desired thickness using a non-woven sheet extrusion system 15. The concentrated mineral masterbatch 02 is mixed separately in a polymer matrix such as PE, with an appropriate compatibilizer 04 in predetermined proportions, using a mechanical mixing device 20 for a predetermined period of time that will ensure a homogeneous mixture. The obtained homogeneous mineral mixture 22 is melted in a melting device 25 to produce a mineral paste 38, which is applied as a coating on both sides of the non-woven PET sheet 33 using a coating device 45 to form an ecological mineral paper 46 that is wound into a roll using a winder 50 to produce a roll of ecological mineral paper 51.

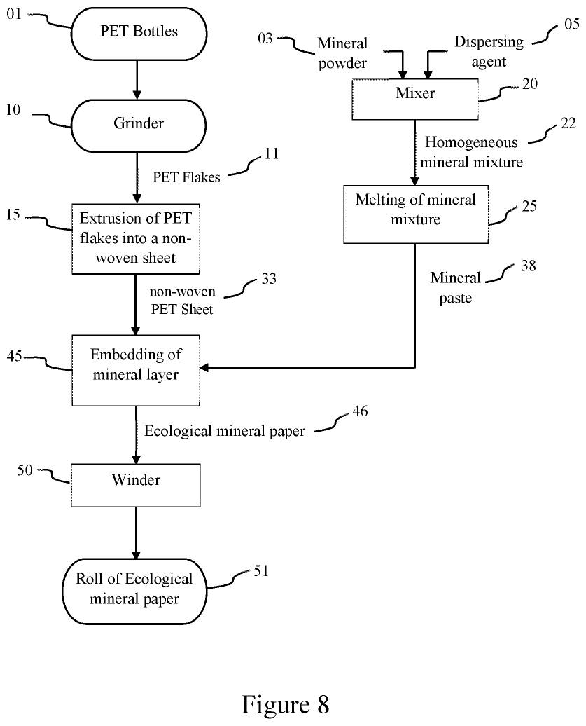

Another manufacturing alternative is shown in FIG. 8, and it is described as follows:
vi. grinding the PET bottle wastes 01 in a grinder 10 to obtain PET flakes 11, which are extruded into a non-woven PET sheet 33 of a desired thickness using a non-woven sheet extrusion system 15. The mineral powder 03 is mixed separately with a dispersing agent 05 in predetermined proportions, using a mechanical mixing device 20 for a predetermined period of time that will ensure a homogeneous mixture. The obtained homogeneous mineral mixture 22 is melted in a melting device 25 to obtain a mineral paste 38, which is applied as a coating on both sides of the non-woven PET sheet 33 using a coating device 45 to form an ecological mineral paper 46 that is wound into a roll using a winder 50 to produce a roll of ecological mineral paper 51.

In each of these embodiments, the shape of the product is not limited to only sheet forms, but it includes films produced by blow extrusion that are cut into a flat shape.

1.-16. (canceled)

17. A synthetic mineral paper, further comprising:
a homogeneous mixture including:
(1) a polymer matrix formed from ground polyethylene terephthalate (PET) flakes in an amount of 33% to 78%;
(2) a concentrated natural mineral masterbatch, in particular calcium carbonate (CaCO₃), talc, or mica, in a polyethylene (PE) polymer matrix, in an amount of 20% to 60%; and
(3) a compatibilizer, in an amount of 1% to 5%;
wherein the homogeneous mixture is extruded into a sheet shape forming a mineral paper, and wherein the mineral paper is wound into a roll of mineral paper.

18. A process of manufacturing a synthetic mineral paper of claim 17, further comprising:
grinding polyethylene terephthalate (PET) wastes in a grinder to obtain ground PET flakes;
mixing the ground PET flakes in an amount of 33% to 78% with a concentrated natural mineral masterbatch, in particular calcium carbonate (CaCO₃), talc, or mica, in a polyethylene (PE) polymer matrix in an amount of 20% to 60%, and a compatibilizer, in an amount of 1% to 5%, using a mechanical mixing device for a predetermined period until forming a homogeneous mixture;
extruding the obtained homogeneous mixture to form a mineral paper of a desired thickness using a sheet extrusion system; and
winding the mineral paper using a winder to produce a roll of mineral paper.

19. A synthetic mineral paper, further comprising:
a homogeneous mixture including:
(1) a polymer matrix formed from ground polyethylene terephthalate (PET) flakes in an amount of 33% to 78%;
(2) a mineral powder, in particular of calcium carbonate (CaCO₃), talc, or mica, in an amount of 20% to 60%; and
(3) a dispersing agent, in particular SOLPLUS, in an amount of 1% to 2%;
wherein the homogeneous mixture is extruded into a sheet shape forming a mineral paper, and wherein the mineral paper is wound into a roll of mineral paper.

20. A process of manufacturing a synthetic mineral paper of claim 19, further comprising:
grinding polyethylene terephthalate (PET) wastes in a grinder in an amount of 33% to 78%, to obtain ground PET flakes;
mixing the ground PET flakes in an amount of 33% to 78% with a mineral powder, in particular of calcium carbonate (CaCO₃), talc, or mica, in an amount of 20% to 60%, and with a dispersing agent, in particular SOLPLUS, in an amount of 1% to 2%, using a mechanical mixing device for a predetermined period until forming a homogeneous mixture;
extruding the homogeneous mixture to form a mineral paper of a desired thickness using a sheet extrusion system; and
winding the mineral paper using a winder to produce a mineral paper roll.

21. A synthetic mineral paper, further comprising:
an extruded sheet formed from ground polyethylene terephthalate (PET) flakes, and
an extruded mineral film formed from a homogeneous mineral mixture of a concentrated mineral masterbatch, in particular calcium carbonate (CaCO₃), talc, or mica, in a polyethylene (PE) polymer matrix, and a compatibilizer;
wherein the extruded sheet and the extruded mineral film are laminated together to form a mineral paper and wound into a mineral paper roll.

22. A process of manufacturing a synthetic mineral paper of claim 21, further comprising:
grinding polyethylene terephthalate (PET) wastes in a grinder to obtain ground PET flakes,
extruding the ground PET flakes to form an extruded PET sheet of a desired thickness using a sheet extrusion system;
mixing separately a concentrated mineral masterbatch, in particular calcium carbonate (CaCO₃), talc, or mica, in a polyethylene (PE) polymer matrix, and a compatibilizer using a mechanical mixing device for a predetermined period until forming a homogeneous mixture;
extruding the homogeneous mixture to form an extruded mineral film of a thickness identical to the thickness of the extruded PET sheet using a flat film extrusion system;
laminating both sides of the extruded PET sheet with a mineral film by means of a laminating device to form a mineral paper; and
winding the mineral paper using a winder to produce a mineral paper roll.

23. A synthetic mineral paper, further comprising:
an extruded sheet formed from ground polyethylene terephthalate (PET) flakes, and
an extruded mineral film formed from a homogeneous mixture of a mineral powder, in particular calcium carbonate (CaCO₃), talc, or mica, and a dispersing agent, in particular SOLPLUS;
wherein the extruded sheet and the extruded mineral film are laminated together to form a mineral paper and wound into a mineral paper roll.

24. A process of manufacturing a synthetic mineral paper of claim 23, further comprising:
grinding polyethylene terephthalate (PET) wastes in a grinder to obtain ground PET flakes,
extruding the ground PET flakes to form an extruded PET sheet of a desired thickness using a sheet extrusion system;
mixing separately a mineral powder, in particular calcium carbonate (CaCO₃), talc, or mica, and a dispersing agent, in particular SOLPLUS, using a mechanical mixing device for a predetermined period until forming a homogeneous mixture;
extruding the homogeneous mixture to form a mineral film of a thickness identical to the thickness of the extruded PET sheet using a flat film extrusion system;
laminating both sides of the extruded PET sheet with a mineral film using a laminating device to form a mineral paper;
winding the mineral paper using a winder to produce a roll of mineral paper.

25. A synthetic mineral paper, further comprising:
an extruded sheet formed from ground polyethylene terephthalate (PET) flakes, and
a melted mineral paste formed from a homogeneous mixture of a concentrated mineral masterbatch, in particular calcium carbonate (CaCO₃), talc, or mica, in a polyethylene (PE) polymer matrix, and a compatibilizer;
wherein the melted mineral paste is embedded in both sides of the extruded sheet to form a mineral paper, which is wound into a roll of mineral paper.

26. A process of manufacturing a synthetic mineral paper of claim 25, further comprising:
grinding polyethylene terephthalate (PET) wastes in a grinder to obtain ground PET flakes,
extruding the ground PET flakes to form an extruded PET sheet of a desired thickness using a sheet extrusion system;
mixing separately a concentrated mineral masterbatch, in particular calcium carbonate (CaCO₃), talc, or mica, in a polyethylene (PE) polymer matrix, and a compatibilizer using a mechanical mixing device for a predetermined period until forming a homogeneous mineral mixture;
melting the homogeneous mineral mixture in a melting device to obtain a mineral paste;
embedding the mineral paste in both sides of the extruded PET sheet by means of a coating device to form a mineral paper;
winding the mineral paper by using a winder to produce a roll of ecological mineral paper.

27. A synthetic mineral paper, further comprising:
an extruded sheet formed from ground polyethylene terephthalate (PET) flakes, and
a melted mineral paste formed from a homogeneous mineral mixture of mineral powder, in particular calcium carbonate (CaCO₃), talc, or mica, and a dispersing agent (05), in particular SOLPLUS;
wherein the melted mineral paste is embedded in both sides of the extruded sheet to form a mineral paper, which is wound into a roll of mineral paper.

28. A process of manufacturing a synthetic mineral paper of claim 27, further comprising:
grinding polyethylene terephthalate (PET) wastes in a grinder to obtain ground PET flakes;
extruding the ground PET flakes to form an extruded PET sheet of a desired thickness using a sheet extrusion system;
mixing separately mineral powder, in particular calcium carbonate (CaCO₃), talc, or mica, and a dispersing agent, in particular SOLPLUS, using a mechanical mixing device for a predetermined period until forming a homogeneous mineral mixture;
melting the homogeneous mineral mixture in a melting device to obtain a mineral paste;
embedding the mineral paste in both sides of the extruded PET sheet by means of a coating device to form a mineral paper;
winding the mineral paper using a winder to produce a mineral paper roll.

29. A synthetic mineral paper, further comprising:
an extruded non-woven sheet formed from ground polyethylene terephthalate (PET) flakes, and
a melted mineral paste formed from a homogeneous mixture of a concentrated mineral masterbatch, in particular calcium carbonate (CaCO₃), talc, or mica, in a polyethylene (PE) polymer matrix, and a compatibilizer;
wherein the melted mineral paste is embedded in both sides of the extruded non-woven sheet to form a mineral paper, which is wound into a roll of mineral paper.

30. A process of manufacturing a synthetic mineral paper of claim 29, further comprising:
grinding polyethylene terephthalate (PET) wastes in a grinder to obtain ground PET flakes,
extruding the ground PET flakes to form an extruded non-woven PET sheet of a desired thickness using a non-woven sheet extrusion system;
mixing separately a concentrated mineral masterbatch, in particular calcium carbonate (CaCO₃), talc, or mica, in a polyethylene (PE) polymer matrix, and a compatibilizer using a mechanical mixing device for a predetermined period until forming a homogeneous mineral mixture;
melting the homogeneous mineral mixture in a melting device to obtain a mineral paste;
applying the mineral paste as a coating on both sides of the extruded non-woven PET sheet by means of a coating device to form a mineral paper;
winding the mineral paper using a winder to produce a roll of mineral paper.

31. A synthetic mineral paper, further comprising:
an extruded non-woven sheet formed from ground polyethylene terephthalate (PET) flakes, and
a melted mineral paste formed from a homogeneous mixture of mineral powder, in particular of calcium carbonate (CaCO₃), talc, or mica, and a dispersing agent, in particular SOLPLUS;
wherein the melted mineral paste is applied as a coating on both sides of the extruded non-woven sheet to form a mineral paper, which is wound into a roll of mineral paper.

32. A process of manufacturing a synthetic mineral paper of claim 31, further comprising:
grinding polyethylene terephthalate (PET) wastes in a grinder to obtain ground PET flakes,
extruding the ground PET flakes to form an extruded non-woven PET sheet of a desired thickness using a non-woven sheet extrusion system;
mixing separately mineral powder, in particular calcium carbonate (CaCO₃), talc, or mica, and a dispersing agent, in particular SOLPLUS, using a mechanical mixing device for a predetermined period until forming a homogeneous mineral mixture;
melting the homogeneous mineral mixture in a melting device to obtain a mineral paste;
applying the mineral paste as a coating on both sides of the extruded non-woven PET sheet by means of a coating device to form a mineral paper;
winding the mineral paper using a winder to produce a roll of mineral paper.
